(19) United States
(12) Patent Application Publication
(10) Pub. No.: US 2015/0153173 A1
(43) Pub. Date: Jun. 4, 2015

(54) DIRECTIONAL INDICATOR

(71) Applicants: Ken Baych, Chaska, MN (US); Danney Winkelman, Waconia, MN (US)

(72) Inventors: Ken Baych, Chaska, MN (US); Danney Winkelman, Waconia, MN (US)

(21) Appl. No.: 14/559,464

(22) Filed: Dec. 3, 2014

Related U.S. Application Data
(60) Provisional application No. 61/911,257, filed on Dec. 3, 2013.

(51) Int. Cl. G01C 17/00

(52) U.S. Cl. CPC G01C 17/00

(57) ABSTRACT

A wearable directional indicator that communicates to a user wearing the indicator a particular orientation by sending a signal to the indicator that alerts the user5 to a particular orientation.

The indicator includes an integrated circuit compass and a microprocessor plus a series of indicators where each indicator is associated with a unique orientation.

This application is a non-provisional application claiming priority from U.S. Provisional Application Ser. No. 61/911,257, filed Dec. 3, 2013, which is fully incorporated herein by reference.

### TECHNICAL FIELD

Navigation information including global orientations (e.g. north, south, etc.) can be of varying degrees of importance to a person at various times. Knowing one's global orientation can be helpful in navigating to a particular destination or crucial and even life-saving when a person has become lost.

### BACKGROUND

Traditionally, one can determine one's global orientation, such as which direction is north, by using established devices, such as a compass, or more recently, computerized directional indicators. Some people possess skills allowing them to determine a global orientation from their surroundings, including the stars, sun, and more immediate environmental clues. However, each of these methods for determining a global orientation require either a requisite skill set for a given environment, or else the use of an external device carried with the user.

Existing devices to assist a user in determining a global orientation require a user to initiate the determining of their orientation, such as retrieving and analyzing the device. In some situations, it can be inconvenient or impossible for the user to retrieve or operate the device, such as in the case of injury or preoccupation of the user, for example. Additionally, one may not know when he or she will need such a device, and may be caught without it. Moreover, skills for determining a global orientation may not always be applicable to a person's environment.

### SUMMARY

Some embodiments of the present invention include wearable articles configured to assist a user in determining his or her global orientation. In wearing the article, a user can be able to determine global orientations at all times. In some embodiments, global orientation information can be relayed to the user subconsciously.

In some embodiments, wearable articles can comprise a linearly arranged series of indicators, such as buzzers, vibrators or speakers, configured to be wrapped around a part of the body. Embodiments can include a microprocessor in communication with a digital compass and configured to energize an appropriate indicator to indicate a particular direction to the user. For example, the processor can be configured to, based on information from the digital compass, cause the indicator in a series of indicators that is most directly facing north to signal to the user which direction is north. The indicator can signal the user by vibrating against a part of the user's body wearing the article, enabling the user to determine a global orientation without the need to visually observe or physically retrieve anything.

Powered components such as the processor, digital compass, and buzzers can be powered by a battery. In some embodiments, the microprocessor is configured to energize the buzzer for a short duration and at predetermined time intervals. Such operating methods can allow for control of the battery life of the system. In some configurations, the battery can last for several years. In addition a consistent duration and interval of signaling can cause the user to be physically unaware of the buzzing, but still realize it subconsciously. Thus, a user can continuously wear the device and receive its benefits without becoming annoyed with the periodic buzzing of the indicators.

### BRIEF DESCRIPTION OF THE DRAWINGS

FIG. 1 is a top perspective view of the circuit board.

FIG. 2 is a top perspective of the control circuit with microprocessor.

FIG. 3 is a side perspective of the digital IC compass and buzzers.

FIG. 4 is a schematic illustrating the process.

### DETAILED DESCRIPTION

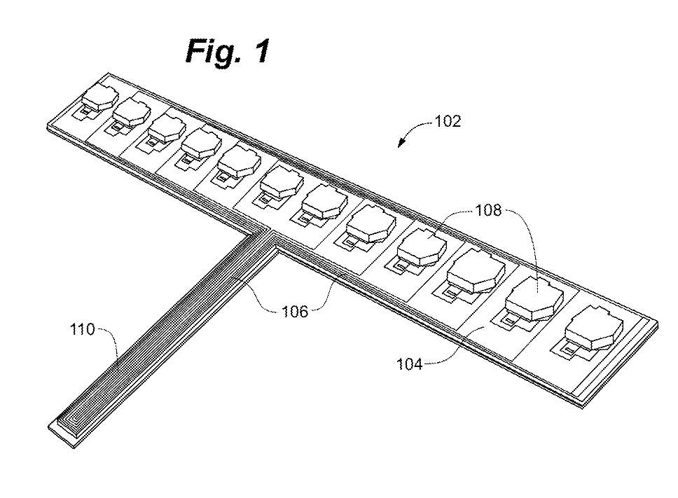

FIG. 1 shows an exemplary circuit to be embedded into a wearable article according to some embodiments of the invention. The circuit 102 comprises an array of buzzers 108 arranged on a flexible circuit board 104. The circuit board can comprise generally any flexible, electrically non-conductive material. Conductive paths 106 are formed in the circuit board 104 and tab connecting each of the buzzers 108 to the end of a tab 110 leading to an activation source for actuating buzzers 108. In some embodiments, signals are sent via tab 110 to one or more appropriate buzzers 108. In other embodiments, each buzzer can receive the same signal such while the signal comprises an address configured to enable only a select buzzer 108 or set of buzzers 108 from the array.

The circuit board 104 of FIG. 1 can be implemented into an article for wear by a user. In some embodiments, the article wraps 360° around a wearer so that, when implemented into the wearable article, a part of the article will face a particular global orientation, such as north, outward from the user. The circuit board 104 can be implemented in the article such that when the article is wrapped 360° around the wearer, buzzers 108 will also be disposed substantially 360° about the user. Among various embodiments, the system can be implemented into articles such as a belt, hat, sweat band, shoe or boot, for example.

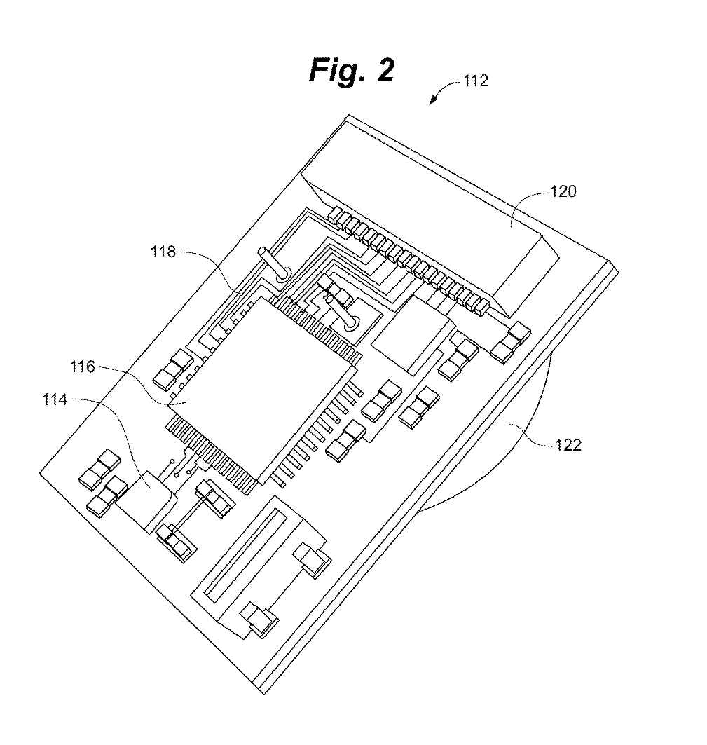

FIG. 2 is an exemplary control circuit for an embodiment of the invention. In the illustrated embodiment, the control circuit 112 comprises a microprocessor 116 in communication with a digital integrated circuit (IC) compass 114. The microprocessor 116 comprises a series of outputs 118 directed toward a connector 120 for interfacing with a flexible circuit board such as that shown in FIG. 1. In some embodiments, the connector 120 interfaces with the tab 110 of the flexible circuit board. The connector 120 can be configured to establish electrical communication between the microprocessor 116 and the buzzers 108 on the flexible circuit board 104. Control circuit 112 can also include a battery 120 for providing power to any powered component, such as the integrated IC compass 114, the microprocessor 116 or the buzzers 108. Techniques such as limiting the frequency of orientation indications and duration of such indications can act to improve battery life of the system. In some cases, a system can operate for a matter of years on a single battery.

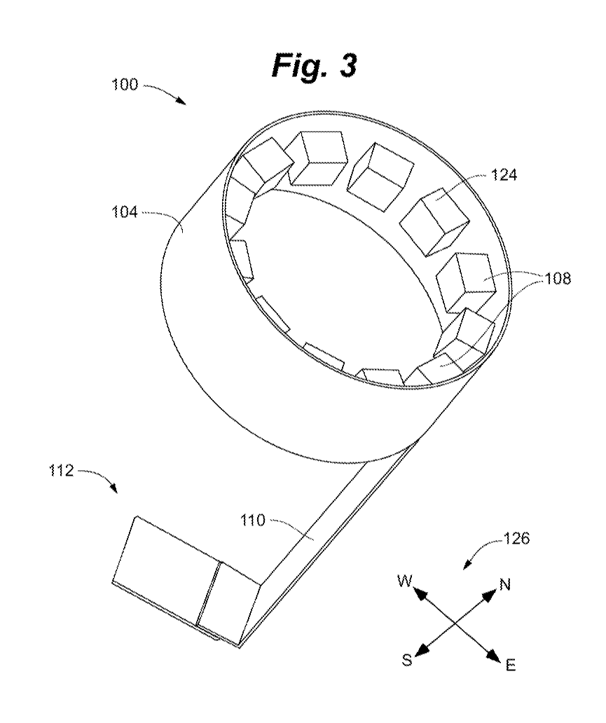

FIG. 3 illustrates an exemplary system for indicating a global orientation to a user. The system 100 includes a flexible circuit board 104 having an array of buzzers 108 displaced along a substantially 360° ring. The flexible circuit board 104 comprises a tab 110 extending toward a control circuit 112 in electrical communication with the buzzers 108 via the tab 110. In the illustrated embodiment, the plane of the control circuit 112 is approximately parallel to the plane formed by the ring of buzzers 108. In such a configuration the global orientation of the digital IC compass and the ring of buzzers 108 can be substantially fixed relative to one another.

Accordingly, if the digital IC compass detects a certain direction to be north, for example, there exists a north-most buzzer 124 located in that same direction from the center of the ring of buzzers 108. The digital IC compass can communicate to the microprocessor which direction is north and the microprocessor can subsequently actuate the north-most buzzer, indicating to a user which direction is north. Such an example is illustrated in FIG. 3, wherein according to the compass 126, the north-most buzzer 124 is highlighted and shown in broken lines, illustrating actuation by the microprocessor. In various embodiments, the control circuit 112 can be configured to indicate any predetermined direction to the user. Some embodiments continually indicate which direction is north.

Certain embodiments are particularly configured to maintain a substantially parallel relationship between the ground, the digital IC compass 114, and the ring of buzzers 108. This way, there will always be a north-most buzzer 124 to indicate north to the user. If instead, for example, the ring was perpendicular to the ground and otherwise extending east-west, there would be no north-most buzzer 124 and a system configured to indicate north to a user would be useless. Accordingly, in some embodiments, the ring of buzzers 108 is designed to encircle a part of a user likely to be parallel with the ground, such as the user's head, neck, waist, and ankle In some embodiments, only the ring of buzzers 108 is substantially parallel with the ground, while the digital compass can determine a direction (e.g., north) in three dimensions.

The illustrative embodiment of FIG. 3 can be configured for use in a shoe or boot. For example, the control circuit 112 can be disposed in the sole of the shoe or boot, under a user's foot, while the ring of buzzers 108 can surround the user's ankle or lower leg. Such a configuration is likely to maintain the parallel relationship between the ring, the control circuit 112, and the ground. In some embodiments, a shoe or boot is manufactured with the device built-in. In other embodiments, the device can be implemented into an existing shoe or boot. Other designs can be used for other articles, such as a hat, a belt, sweat band, and others.

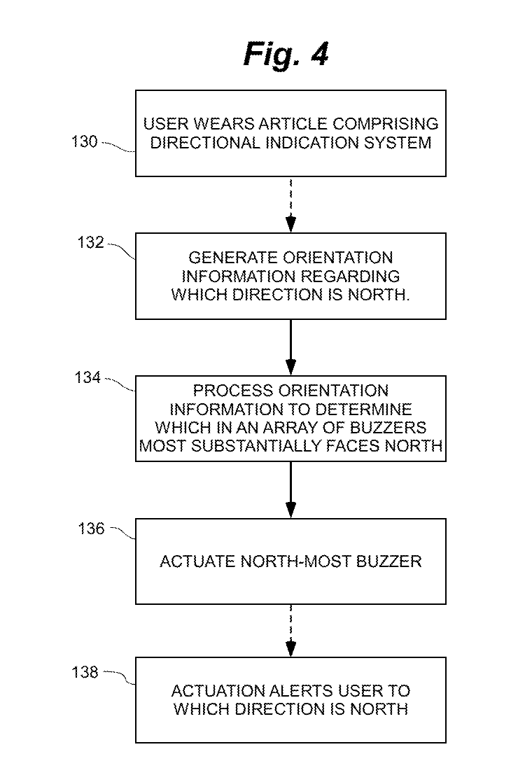

FIG. 4 is a process flow diagram outlining basic operation of an exemplary directional indication system. A user can wear 130 an article comprising the directional indication system. During operation, the system is configured to generate 132 orientation information regarding which direction is north. In some systems, orientation information is generated by a directional indicator, such as a digital IC compass. The system can further process 134 the orientation information to determine which in an array of buzzers most substantially faces north. The processing can be performed by a microprocessor, for example. In various embodiments, the digital IC compass can send orientation information to the microprocessor, or the microprocessor can sample the digital IC compass and retrieve orientation information therefrom.

Once the north-most buzzer is determined, the system can be configured to actuate 136 the north-most buzzer. Actuation of the buzzer can alert 138 the user/wearer to which direction is north. The process steps of a user wearing 130 an article comprising the system and the user being alerted 138 by the system are shown in broken lines, as they do not necessarily represent process steps performed by the system, but still represent generic steps in system use, according to some embodiments. While north is indicated to the user in the described embodiment, in general, any direction determinable by a directional indicator such as a digital IC compass can be relayed to the user.

Various non-limiting examples have been described. It will be appreciated that these and others fall within the scope of the invention.

1. A wearable directional indicator comprising:
a series of indicators located on a wearable item wherein the series of indicators are substantially parallel to the ground when the item is worn by a user and wherein each indictor is associated with a unique orientation;
a compass incorporated in an integrated circuit wherein the compass detects an orientation; and
a microprocessor operatively coupled to the compass and the series of indicators wherein the compass communicates the detected orientation to the microprocessor and the microprocessor activates one of the series of indicators associated with the detected orientation.

2. The indicator according to claim 1 wherein the series of indicators are buzzers.

3. The indicator according to claim 1 wherein the series of indicators are vibrators.

4. The indicator according to claim 1 wherein the wearable item is a belt.

5. The indicator according to claim 1 wherein the wearable item is a strap to be worn around an ankle, arm, chest or head.

6. The indicator according to claim 1 wherein the wearable item is a boot.

7. The indicator according to claim 1 wherein the series of indicators forms a ring.

8. The indicator according to claim 1 wherein the orientation is north.

9. The indicator according to claim 1 wherein the microprocessor activates one the series of indicators periodically.

10. The indicator according to claim 1 wherein the microprocessor activates one the series of indicators continuously.

11. The indicator according to claim 1 wherein the microprocessor activates one the series of indicators repeatedly for a predetermined amount of time.

12. A method of indicating orientation to a user comprising:
wearing an article having a series of indicators that are substantially parallel to the ground when the item is worn by a user and wherein each indicator is associated with a unique orientation, a compass incorporated in an integrated circuit wherein the compass detects an orientation, and a microprocessor operatively coupled to the compass and the series of indicators wherein the compass communicates the detected orientation to the microprocessor and the microprocessor activates one of the series of indicators associated with the detected orientation;
generating orientation information with the compass;
processing the orientation formation to determine with indicator of the series of indicators is associated with the detected orientation; and
activating the associated indicator to indicate to the user the detected orientation.
